(19) United States
(12) Patent Application Publication
(10) Pub. No.: US 2005/0001111 A1
(43) Pub. Date: Jan. 6, 2005

(54) Armrest elevation apparatus

(76) Inventor: Ching-Chang Wang, Taichung Hsien (TW)

Correspondence Address: BIRCH STEWART KOLASCH & BIRCH, PO BOX 747, FALLS CHURCH, VA, 22040-0747, US

(21) Appl. No.: 10/610,880

(22) Filed: Jul. 2, 2003

(51) Int. Cl. B68G 5/00

(52) U.S. Cl. 248/118

(57) ABSTRACT

An elevation apparatus is provided for an armrest. The elevation apparatus includes a support, a stationary element, a movable element and a latch. The stationary element is supported on the support. The stationary element includes a series of holes overlapping one another, thus forming a pair of teeth between adjacent two of the holes. The movable element is movably connected with the stationary element for supporting the armrest. The movable element defines a hole. The latch includes a thick portion longitudinally inserted in the hole of the movable element and a thin portion transversely movable past the pairs of teeth. The latch is movable between a locking position and a releasing position. In the locking position, the thick portion is in one of the holes of the stationary element. In the releasing position, the thin portion is in the series of holes of the stationary element.

### FIELD OF THE INVENTION

The present invention relates to an armrest elevation apparatus.

### BACKGROUND OF THE INVENTION

Taiwanese Patent Publication No. 361168 discloses an armrest elevation device including a stationary element 1, a movable element 2, a latch 3, a spring 6, a bolt 7, a leaf spring 4 and a retaining element 5. The stationary element 1 defines a slot 13 and recesses 12. The movable element 2 is attached to the stationary element 1. The movable element 2 defines a shallow cavity 22, a deep cavity 23 in the bottom of the shallow cavity 22, a dent 25 communicated with the deep cavity 23 and a hole 24 through the bottom of the shallow cavity 22. The latch 3 is put in the deep cavity 23. The latch 3 includes a hole 31 and a dent 32. The spring 6 includes an end put in the dent 25 and an opposite end put in the dent 32 so that it pushes the latch 3 on the movable element 2. The bolt 7 is driven into the hole 31 through the hole 24. The leaf spring 4 is put in the shallow cavity 22. The leaf spring 4 is bent and defines a hole 41 through which the bolt 7 extends. The retaining element 5 is put in the shallow cavity 22. Two edges of the leaf spring 4 contact the movable element 2. The bent portion of the leaf spring 4 contacts the retaining element 5. The retaining element 5 defines a hole 51 and a narrower hole 52, with a cape formed between them. As the movable element 2 is moved relative to the stationary element 1 in a first direction, the retaining element 5 is moved in a second direction on the movable element 2 because the friction between the retaining element 5 and the stationary element 1 is greater than the friction between the retaining element 5 and the leaf spring 4. The bolt 7 is in the hole 51 so that it can slide from one recess 12 one after another. The movable element 2 must be moved in the first direction until the bolt 7 reaches an end of the slot 13 before the movable element 2 can be moved relative to the stationary element 1 in the second direction. The slot 13 retains the bolt 7 so that the cape can move past the bolt 7. Further sliding of the movable element 2 relative to the stationary element 1 in the first direction moves the cape past the bolt 7 so that the bolt 7 enters the hole 52. After this, the movable element 2 can be moved in the second direction as the bolt 7 is retained in the hole 52 and therefore in the slot 13, i.e. the bolt 7 cannot enter any recess 12. After the bolt 7 reaches an opposite end of the slot 13, the cape moves past the bolt 7 as the movable element 2 continues to move relative to the stationary element 1 in the second direction. That is, the bolt 7 enters the hole 51. As the bolt 7 is in the hole 51, the movable element 2 can be moved in the first direction and the bolt 7 retained in one recess 12 again. This conventional elevation device is however inconvenient in operation and complicated in structure.

### SUMMARY OF INVENTION

It is an objective of the present invention to provide an arm elevation apparatus that is convenient in operation.

It is another objective of the present invention to provide an arm elevation apparatus that is simple in structure.

According to the present invention, an elevation apparatus includes a support, a stationary element, a movable element and a latch. The stationary element is supported on the support. The stationary element includes a series of holes overlapping one another, thus forming a pair of teeth between adjacent two of the holes. The movable element is movably connected with the stationary element for supporting the armrest. The movable element defines a hole. The latch includes a thick portion longitudinally inserted in the hole of the movable element and a thin portion transversely movable past the pairs of teeth. The latch is movable between a locking position and a releasing position. In the locking position, the thick portion is in one of the holes of the stationary element. In the releasing position, the thin portion is in the series of holes of the stationary element.

Other objects, advantages, and novel features of the invention will become more apparent from the following detailed description when taken in conjunction with the attached drawings.

### BRIEF DESCRIPTION OF DRAWINGS

The present invention will be described via detailed illustration of the preferred embodiment referring to the drawings.

FIG. 1 is a perspective view of an elevation apparatus for an armrest according to the preferred embodiment of the present invention.

FIG. 2 is an exploded view of the elevation apparatus of FIG. 1.

FIG. 3 is a cross-sectional view of the elevation apparatus of FIG. 1.

FIG. 4 is a cross-sectional view taken along a line 4-4 in FIG. 3.

FIG. 5 is similar to FIG. 4 but showing the elevation apparatus in a different position.

FIG. 6 is similar to FIG. 3 but showing the elevation apparatus in a different position.

### DETAILED DESCRIPTION OF PREFERRED EMBODIMENT

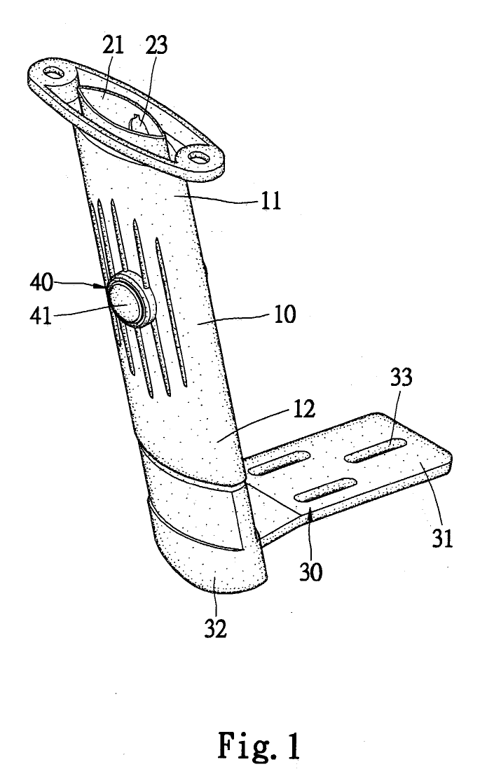

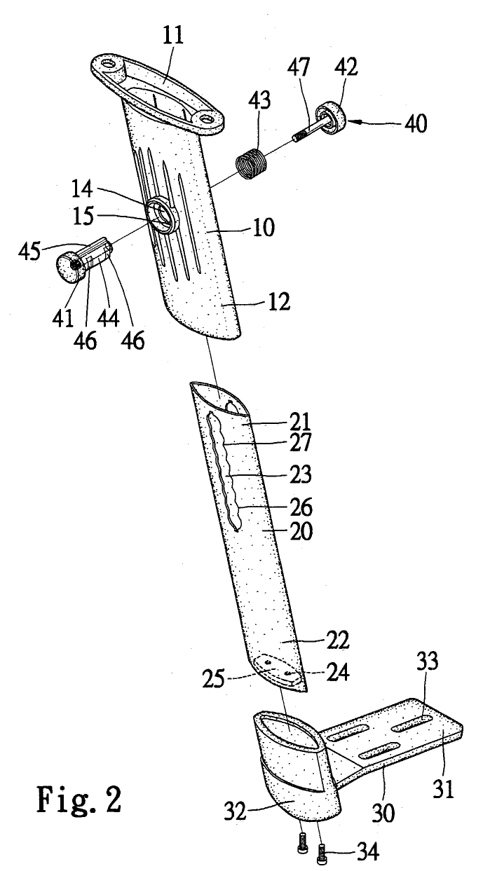

Referring to FIGS. 1-3, according to the preferred embodiment of the present invention, an elevation apparatus for an armrest includes a support 30, a stationary column 20 installed on the support 30, a movable column 10 movably installed on the stationary column 20 and a control device 40 for retaining the movable column 10 in position on the stationary column 20. In use, the support 30 is attached to a seat of a chair (not shown), and an armrest (not shown) is installed on the movable column 10.

The support 30 includes a plate 31 extending horizontally and a socket 32 extending vertically from the plate 31. The plate 31 defines a number of slots 33. Two holes 35 are defined in a plate 36 formed on an internal side of the socket 32.

A corresponding number of bolts (not shown) can be driven through the slots 33 into the seat so as to secure the support 30 to the seat.

The stationary column 20 includes a lower end 22 and an upper end 21. Two holes 24 are defined in a plate 25 formed on an internal side of the stationary column 20 near the lower end 22. Two opposite slots 23 are defined in the stationary column 20 near the upper end 21. Each slot 23 consists of a number of holes 26 overlapping one another. A pair of teeth 27 is formed between two adjacent holes 26.

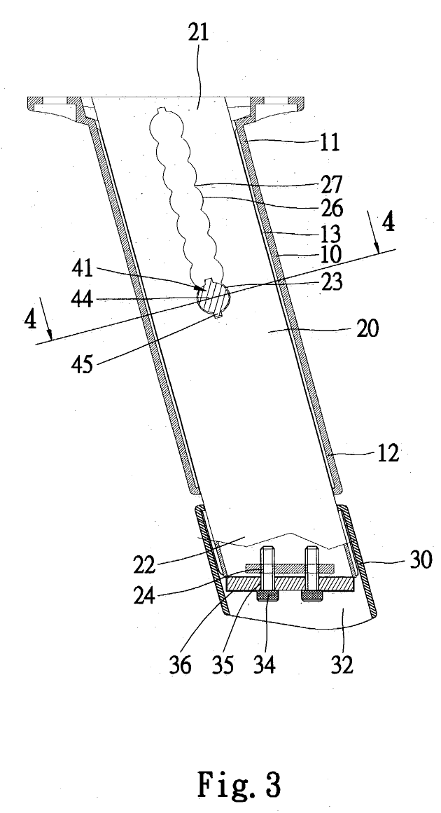

As best shown in FIG. 3, the lower end 22 is inserted in the socket 32. Two bolts 34 are driven into the holes 24 through the holes 35, thus securing the lower end 22 to the socket 32.

The movable column 10 includes a lower end 12 into which the upper end 21 of the stationary column 20 is inserted and an upper end 11 on which the armrest is installed. Two opposite holes 14 are defined in the movable column 10. Two opposite recess 15 are defined in the edge of each hole 14.

The control device 40 includes a latch 41, a button 42 and a spring 43. The latch 41 includes a tube 44 and two opposite ridges 45 formed on the external side of the tube 44. The tube 44 includes two necks 46 formed thereon. Each neck 46 is formed by means of cutting a pair of recesses (not numbered) into an external side of the tube 44. The button 42 includes a bolt 47 extending from a side thereof.

The tube 44 is inserted into the holes 14 and the slots 23. The ridges 45 are put in the recesses 15 so as to avoid rotation of the latch 41 relative to the movable column 10. The bolt 47 is driven into the tube 44 through the spring 43.

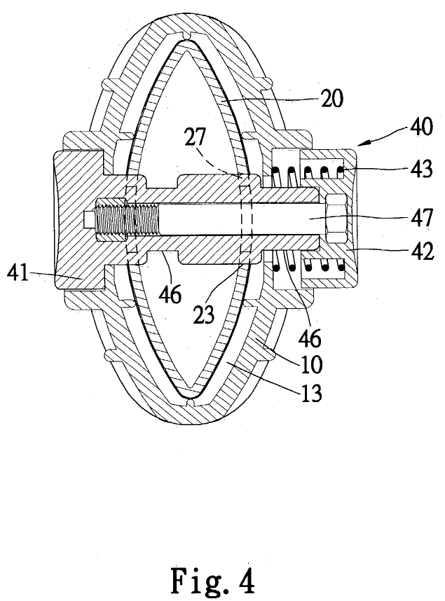

Referring to FIG. 4, the button 42 is released. The tube 44 is retained in one hole 26 of each slot 23. Thus, the movable column 10 is retained in position relative to the stationary column 20.

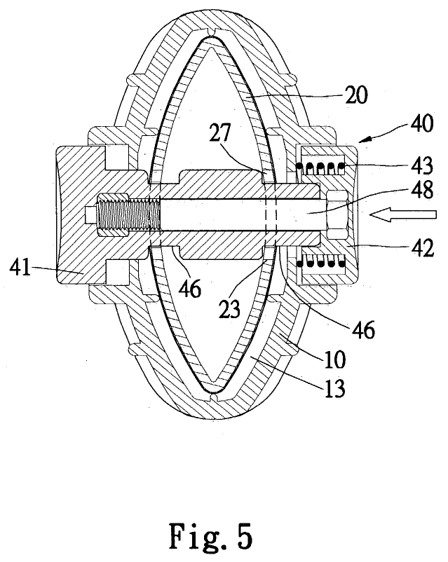

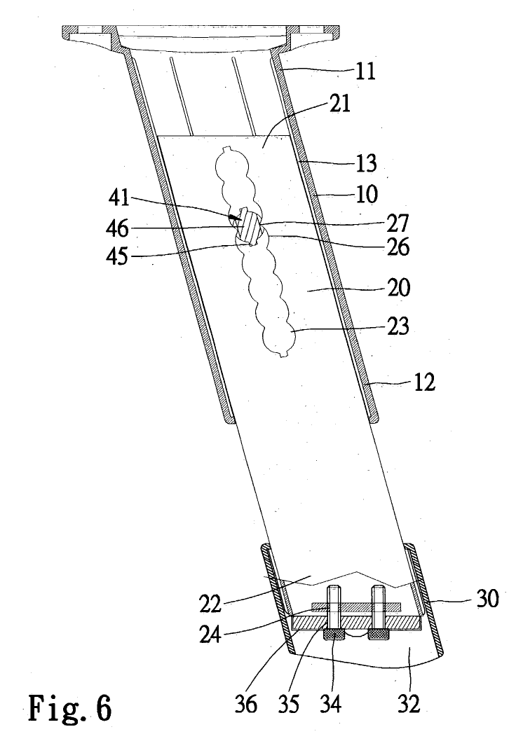

Referring to FIGS. 5 and 6, the button 42 is pushed. The necks 46 are aligned with the slots 23. The necks 46 can be moved past the pairs of teeth 27. Thus, the movable column 10 can be moved relative to the stationary column 20.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. An elevation apparatus for an armrest including:
a support;
a stationary element supported on the support, the stationary element including a series of holes overlapping one another, thus forming a pair of teeth between adjacent two of the holes;
a movable element movably connected with the stationary element for supporting the armrest, the movable element defining a hole; and
a latch including a thick portion longitudinally inserted in the hole of the movable element and a thin portion transversely movable past the pairs of teeth, the latch being movable between a locking position where the thick portion is in one of the holes of the stationary element and a releasing position where the thin portion is in the series of holes of the stationary element:

2. The elevation apparatus according to claim 1 including a spring for biasing the latch to the locking position.

3. The elevation apparatus according to claim 2 including a block attached to the latch in order to facilitate the movement of the latch.

4. The elevation apparatus according to claim 3, wherein the block is a button.

5. The elevation apparatus according to claim 4, wherein the spring is compressed between the button and one of the movable element and the stationary element.

6. The elevation apparatus according to claim 3, wherein the latch is a tubular element, and the block includes a bolt driven into the latch.

7. The elevation apparatus according to claim 1, wherein the movable element defines a recess in the edge of the hole thereof, and the latch includes a ridge inserted in the recess of the movable element, thus avoiding rotation of the latch relative to the movable element.

8. The elevation apparatus according to claim 1, wherein the movable element is a tubular element in which the stationary element is inserted.

9. The elevation apparatus according to claim 9, wherein the movable element defines two opposite holes through which the latch extends.

10. The elevation apparatus according to claim 1, wherein the stationary element is a tubular element in which the movable element is inserted.

11. The elevation apparatus according to claim 10, wherein the stationary element defines two opposite series of holes through which the latch extends.
